(19) United States
(12) Patent Application Publication
(10) Pub. No.: US 2024/0297541 A1
(43) Pub. Date: Sep. 5, 2024

(54) ELECTRIC MOTOR

(71) Applicant: TOYOTA JIDOSHA KABUSHIKI KAISHA, Aichi (JP)

(72) Inventors: Takahiro SAITO, Okazaki-shi (JP); Kyoko NAKAMURA, Nagoya-shi (JP); Hikohito YAMAZAKI, Toyota-shi (JP)

(21) Appl. No.: 18/583,772

(22) Filed: Feb. 21, 2024

(30) Foreign Application Priority Data
Mar. 2, 2023 (JP) 2023-031691

(51) Int. Cl. H02K 1/2783; H02K 29/03

(52) U.S. Cl. CPC H02K 1/2783; H02K 29/03

(57) ABSTRACT

An electric motor has a rotor with a plurality of magnets arranged on a surface of the rotor. When viewed along an axial direction of the rotor, the plurality of magnets may have following features: a direction of a magnetic pole of each of the plurality of magnets is rotated by 45 degrees sequentially from one to next along a circumferential direction of the rotor; and a width of each of the magnets of which the magnet pole direction is inclined by 45 degrees relative to a radial direction of the rotor is wider than a width of each of the magnets of which the magnet pole direction coincides with the circumferential direction or the radial direction.

### REFERENCE TO RELATED APPLICATION

This application claims priority from Japanese Patent Application No. 2023-031691 filed on Mar. 2, 2023. The entire contents of the priority application are incorporated herein by reference.

### TECHNICAL FIELD

The technology disclosed herein relates to an electric motor in which permanent magnets are arranged on a surface of a rotor.

### BACKGROUND

The “Halbach arrangement” is known as one method of arranging permanent magnets on a surface of a rotor. The “Halbach arrangement” is to arrange a plurality of permanent magnets so that a magnetic pole direction in each of the permanent magnets rotates sequentially from one magnet to the next magnet at an equal angle along a circumferential direction of the rotor. It is known that the Halbach arrangement increases efficiency of an electric motor (e.g., JP-A-1999-308793, JP-A-2009-261167).

### SUMMARY

### Description

The technology disclosed herein relates to an improved Halbach arrangement of rotor's surface magnets. The technology disclosed herein can reduce torque ripple in an electric motor.

The electric motor disclosed herein has a rotor with a plurality of magnets arranged on its surface. The plurality of magnets has the following features when viewed along an axial direction of the rotor. (1) The plurality of magnets is arranged so that a direction of a magnetic pole of each of the plurality of magnets is rotated by 45 degrees sequentially from one to next along a circumferential direction of the rotor; and (2) a width of each of the magnets of which the magnet pole direction is inclined by 45 degrees relative to a radial direction of the rotor is wider than a width of each of the magnets of which the magnet pole direction coincides with the circumferential direction or the radial direction.

With the above two features, magnetic flux density distribution (density distribution along the circumferential direction of the rotor) in a gap between the rotor and a stator comes close to a sinusoidal wave. Since the magnetic flux density distribution comes close to a sinusoidal wave, the rotor rotates smoothly and torque ripple can be suppressed.

Details of the technology disclosed herein and further improvements are described in the “Detailed Description below.

### BRIEF DESCRIPTION OF DRAWINGS

FIG. 1 shows a cross-sectional view of an electric motor according to an embodiment and taken along a plane perpendicular to an axis line.

FIG. 2 is an enlarged cross-sectional view of only a rotor of FIG. 1.

FIG. 3 shows distribution of magnetic flux density in a gap between a rotor and a stator.

FIG. 4 shows a relationship between ratio of magnet width and motor output torque.

FIG. 5 shows a relationship between ratio of magnet width and torque ripple.

### DETAILED DESCRIPTION

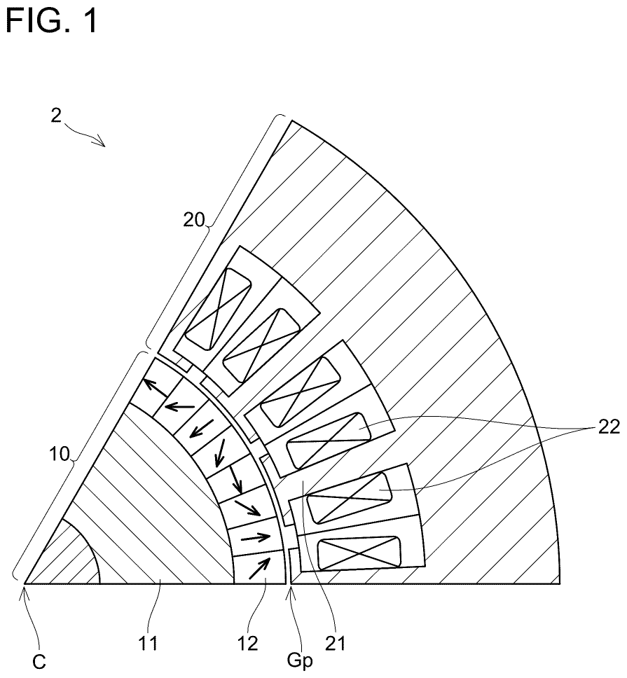

An electric motor 2 according to an embodiment is described with reference to the drawings. FIG. 1 shows a cross-section of the electric motor 2 taken along a plane perpendicular to an axis line. In other words, FIG. 1 corresponds to a view of a rotor 10 and a stator 20 viewed along an axial direction of the rotor 10. In FIG. 1, only a part of the rotor 10 and stator 20 of the electric motor 2 is shown. Specifically, in FIG. 1, only a 60-degree fan-shaped area of the rotor 10 and stator 20 is shown. The rest of the rotor 10 and stator 20 is a repetition of the structure shown in FIG. 1. The rotor 10 is columnar and the stator 20 is cylindrical arranged coaxially with the rotor 10.

The rotor 10 has a rotor core 11 constituted of a magnetic material and a plurality of magnets 12 arranged on a surface of the rotor core 11. In FIG. 1, a reference numeral 12 is shown for one magnet only, and the numerals are omitted for the remaining magnets. The magnets 12 are permanent magnets. The structure in which permanent magnets are arranged on the surface of the rotor is called a surface permanent magnet motor (SPM motor).

The stator 20 has a plurality of teeth 21 and a coil 22 wound around each of the plurality of teeth 21. The plurality of coils 22 are divided into three types (U-phase coil, V-phase coil, and W-phase coil); when a sinusoidal current with a phase shift of 120° is applied to the three types of coils, the rotor 10 rotates.

A gap Gp is secured between the surface of the rotor 10 and the surfaces of the teeth 21 of the stator 20.

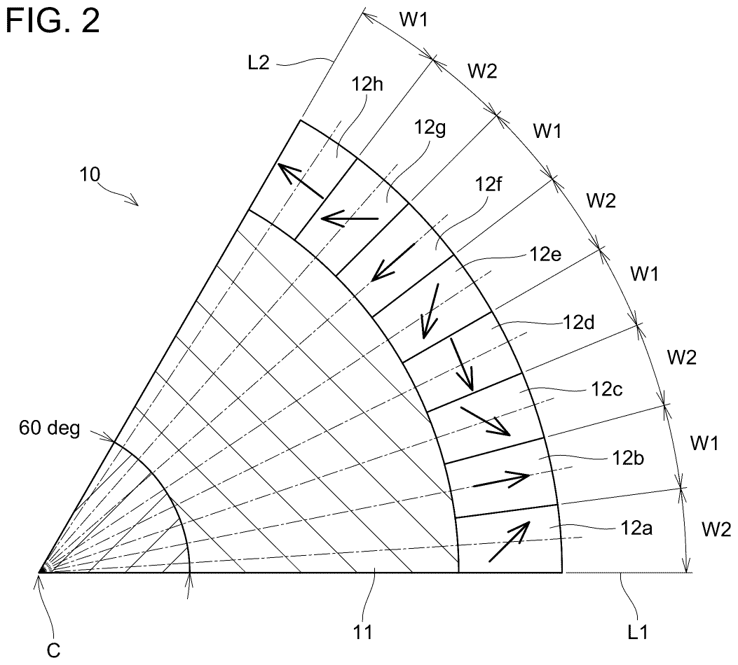

In FIG. 1, arrows drawn on each of the plurality of magnets 12 indicate directions of their magnetic poles. The directions of the magnetic poles of the plurality of magnets 12 will be explained with reference to FIG. 2. FIG. 2 is an enlarged view of the rotor 10 in FIG. 1. The stator 20 is omitted in FIG. 2.

Eight magnets are arranged on the surface of the rotor core 11, from magnet 12a to magnet 12h, within a fan shape of 60 degrees. 8 magnets 12a-12h are aligned along a circumferential direction of the rotor 10. Each of the arrows marked in the magnets 12a-12h indicates the direction of the magnetic pole. Each of the one-dot dashed lines in FIG. 2 is a straight line passing through both a center C of the rotor 10 and a center of each magnet. In other words, each of the one-dot dashed lines in FIG. 2 is a straight line extending in a radial direction of the rotor 10.

For the magnets 12b and 12f, the direction of the magnetic pole (direction of the arrow) is aligned with the radial direction. For the magnets 12d and 12h, the direction of the magnetic pole (direction of the arrow) is orthogonal to the radial direction. In other words, each of the magnets 12d and 12h has the direction of the magnetic pole (direction of the arrow) coinciding with the circumferential direction. For the magnets 12a, 12c, 12e, and 12g, the direction of the magnetic pole (direction of the arrow) is inclined 45 degrees relative to the radial direction. More precisely, each of the magnets 12a, 12c, 12e, and 12g has the direction of the magnetic pole (direction of the arrows) inclined 45 degrees or −45 degrees relative to the radial direction.

As well represented in FIG. 2, the magnets 12a-12h are arranged so that each of their magnetic poles is rotated sequentially by 45 degrees from one to the next along the circumferential direction of rotor 10. From the magnet 12a to the magnet 12h, the directions of the magnetic poles change by 45 degrees in a clockwise rotation. FIG. 2 shows the 60-degree fan-shaped portion of the rotor 10. In the remaining 300-degree portion of the rotor 10, the magnet arrangement of FIG. 2 is repeated. That is, a number of magnets are arranged along the circumferential direction on the surface of the rotor 10, and they are arranged so that the direction of each of the magnetic poles is rotated sequentially from one to the next by 45 degrees over the entire circumference. A magnet arrangement in which each of the magnetic poles is rotated sequentially along the circumferential direction of a rotor is called a Halbach arrangement. Usually, multiple magnets are arranged so that the magnetic poles rotate at equal angles. The magnets 12a-12h are rectangular-pillar shaped when viewed along the axial direction of the rotor 10, and two sides extending in the radial direction are the same length. The magnets 12a-12h have no gap between adjacent magnets in the circumferential direction.

Reference signs W1 and W2 in FIG. 2 represent widths of the magnets. The width of the magnets 12b, 12d, 12f, and 12h is W1. The width of the magnets 12a, 12c, 12e, and 12g is W2. For the magnets 12b and 12f, the magnetic pole coincides with the radial direction, and for the magnets 12d and 12h, the magnetic pole coincides with the circumferential direction (perpendicular to the radius) of the rotor 10. For the magnets 12a, 12c, 12e, and 12g, the magnetic pole is inclined 45 degrees (or −45 degrees) relative to the radial direction. The width W2 is wider than the width W1. In other words, the width W2 of the magnets 12a, 12c, 12e, and 12g, whose magnetic poles are inclined 45 degrees (or −45 degrees) relative to the radial direction, is wider than the width W1 of magnets 12b, 12d, 12f, and 12h, whose magnetic poles coincide with the radial direction or with the circumferential direction. It should be noted that, in FIG. 2, the widths W1 and W2 are drawn with the same length for convenience of drawing.

For convenience of explanation, the magnets 12b, 12d, 12f, and 12h, whose magnetic poles coincide with the radial or circumferential direction, will be referred to as 0-degree magnets, and the magnets 12a, 12c, 12e, and 12g, whose magnetic poles are inclined 45 degrees (or −45 degrees) relative to the radial direction, will be referred to as 45-degree magnets. In the electric motor 2 according to the embodiment, the width W2 of the 45-degree magnets is wider than the width W1 of the 0-degree magnets.

The electric motor 2 according to the embodiment has the following features. The plurality of the magnets 12a-12h aligned in the circumferential direction is arranged on the surface of the rotor 10. The magnets 12a-12h are permanent magnets. The plurality of magnets 12a-12h are arranged so that the direction of each of the magnetic poles is rotated by 45 degrees sequentially from one to the next along the circumferential direction. The magnetic pole of at least one magnet coincides with the radial direction, while the magnetic pole of at least one other magnet coincides with the circumferential direction. The width W2 of the magnets 12a, 12c, 12e, and 12g, whose magnetic poles are at an angle of 45 degrees relative to the radial direction, is wider than the width W1 of the magnets 12b, 12d, 12f, and 12h, whose magnetic poles coincides with the circumferential direction or the radial direction.

Advantages of the above features will be described below. The magnets 12a-12h in FIG. 2 produce magnetic flux in the gap Gp. Density of the magnetic flux at the gap Gp will be referred to as surface flux density for the sake of explanation.

As the direction of each of the magnetic poles changes sequentially from the magnet 12a to magnet 12h, the surface magnetic flux density also changes. In other words, the rotor 10 with the plurality of magnets arranged so that each of the magnetic poles is rotated sequentially produces distribution of the surface magnetic flux density that varies along the circumferential direction of the rotor 10.

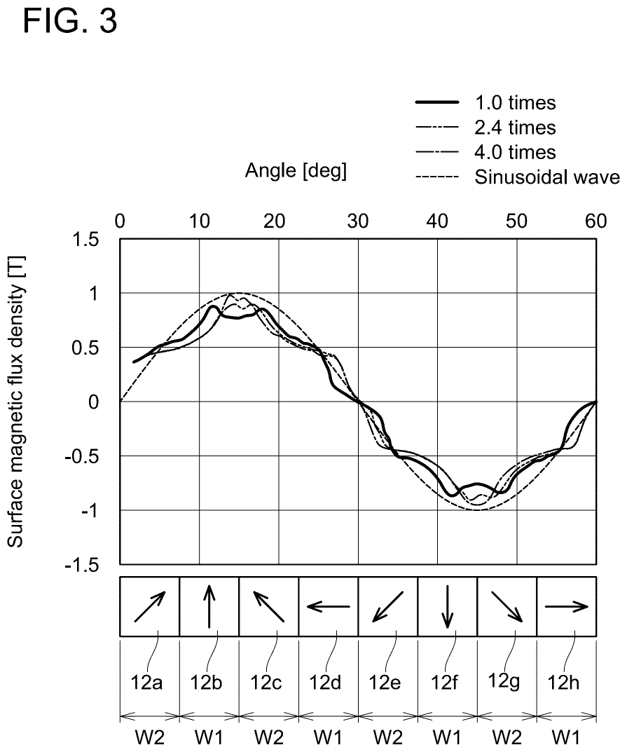

FIG. 3 shows the distribution of the surface magnetic flux density. A left end of the graph in FIG. 3 corresponds to straight line L1 in FIG. 2. A right end of the graph in FIG. 3 corresponds to straight line L2 in FIG. 2. FIG. 3 shows change in the surface magnetic flux density between the straight line L1 and the straight line L2 in FIG. 2. The magnets 12a-12h are aligned between the left and right ends of the graph in FIG. 3. The magnets 12a-12h are drawn below the graph in FIG. 3. The magnets 12a-12h produce the change in the magnetic flux shown by the graph in FIG. 3.

A dotted line graph in FIG. 3 shows an ideal sinusoidal wave. A solid line graph shows change in the surface magnetic flux density when the width W2 is 1.0 times the width W1. In other words, the solid line graph shows change in the surface magnetic flux density when the width W2 is equal to the width W1. A two-dot dashed line graph shows change in the surface magnetic flux density when the width W2 is 2.4 times the width W1. A one-dot dashed line graph shows change in the surface magnetic flux density when the width W2 is 4.0 times the width W1. The larger the width W2 is as compared to the width W1, the more the change in the surface magnetic flux density comes close to the sinusoidal wave. The more the change in the surface magnetic flux density produced by the rotor 10 comes close to the sinusoidal wave, the more smoothly the rotor 10 rotates. In other words, the more the change in the surface magnetic flux density produced by the rotor 10 comes close to the sinusoidal wave, the smaller the torque ripple produced by the electric motor 2.

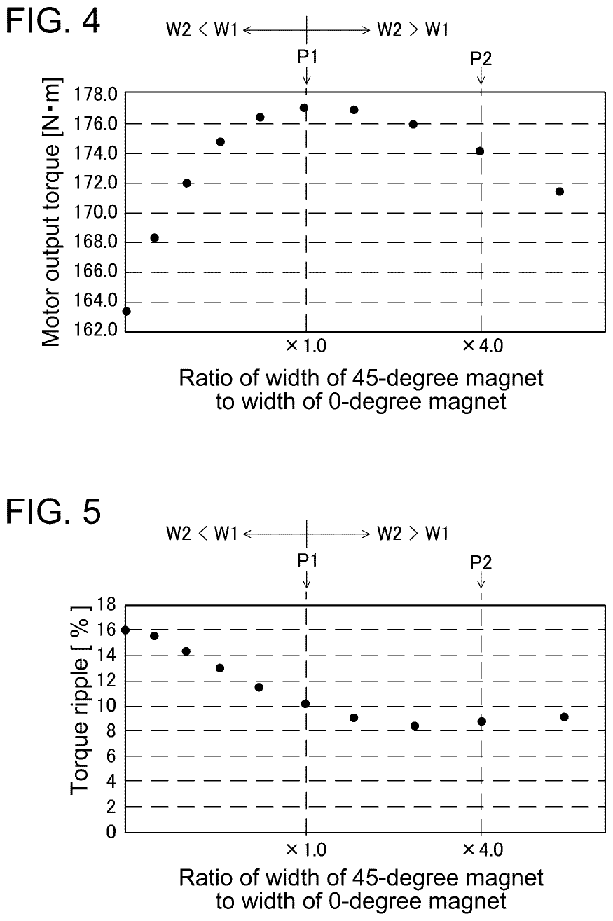

As mentioned earlier, for convenience of explanation, the magnets 12b, 12d, 12f, and 12h, whose magnetic poles coincide with the radial direction or circumferential direction, will be referred to as 0-degree magnets, and the magnets 12a, 12c, 12e, and 12g, whose magnetic poles are inclined 45 degrees (or −45 degrees) relative to the radial direction, will be referred to as 45-degree magnets. In the electric motor 2 according to the embodiment, the width W2 of the 45-degree magnets is wider than the width W1 of the 0-degree magnets. FIG. 4 shows a relationship between ratio of magnet width and motor output torque. FIG. 5 shows a relationship between ration of magnet width and torque ripple. A horizontal axis in FIGS. 4 and 5 represents magnification of the 45-degree magnet width W2 relative to the 0-degree magnet width W1.

FIG. 4 shows the relationship between ratio of magnet width and motor output torque. FIG. 5 shows the relationship between ratio of magnet width and torque ripple. A point P1 in FIGS. 4 and 5 corresponds to the case where widths W1 and W2 are equal. In FIGS. 4 and 5, the width W2 is narrower than the width W1 on the left side of the point P1. On the right side of the point P1, the width W2 is wider than the width W1. A point P2 in FIGS. 4 and 5 corresponds to the case where the width W2 is 4.0 times wider than the width W1.

The higher the surface flux density, the higher the output torque of the motor. In the electric motor 2 with Halbach arrangement, as shown in FIG. 4, when the widths (circumferential widths) of the magnets at 0°, 45° (−45°), and 90° are the same (i.e., point P1), the output torque takes a local maximum value. On the other hand, as mentioned in the explanation of FIG. 3, the larger the width W2, the smaller the torque ripple becomes (FIG. 5) because the distribution in the surface magnetic flux density comes close to a sinusoidal wave. It is in a range of 1.0<W2/W1<4.0 that the output torque does not significantly decrease and the torque ripple becomes smaller.

The electric motor 2 according to the embodiment has the following features. The electric motor 2 has the plurality of magnets 12a-12h on the surface of the rotor 10. The plurality of magnets 12a-12h is aligned in the circumferential direction of the rotor 10. The plurality of magnets 12a-12h is arranged so that when viewed along the axial direction of the rotor 10, each of the magnetic pole directions is rotated by 45 degrees sequentially from one to the next along the circumferential direction. The width W2 of the 45-degree magnets (magnets 12a, 12c, 12e, and 12g whose magnetic pole is inclined 45 degrees (or −45 degrees) relative to the radial direction) are wider than the width W1 of the 0-degree magnets (the magnets 12b, 12d, 12f, 12h whose magnetic pole coincides with the circumferential direction or the radial direction). In other words, the ratio of width W2 to the width W1 (W2/W1) is greater than 1.0. The ratio of the width (W2/W1) is preferably less than 4.0.

As shown in FIGS. 1 and 2, each of boundaries between the 45-degree magnet and 0-degree magnet is a straight line when viewed along the axial direction of the rotor 10. More precisely, each of the boundaries between the 45-degree magnet and 0-degree magnet completely overlaps a straight line extending in the radial direction. In other words, when viewed along the axial direction of the rotor 10, each of the 45-degree magnets and 0-degree magnets has a Baumkuchen shape surrounded by two parallel circular arcs and two straight lines radiating from a center of the circular arcs (i.e., the center C of the rotor 10). When the line of the boundary between the 45-degree magnet and the 0-degree magnet is curved or bended, the torque ripple reduction effect may be smaller because the change in surface magnetic flux density is farther from a sinusoidal wave. When viewed along the axial direction of the rotor 10, the line of the boundary between the 45-degree magnet and 0-degree magnet preferably completely overlaps a straight line extending in the radial direction of the rotor 10.

Points to be noted on the technique described in the embodiment will be as follows. It is clear from FIG. 2 that when the width W2=the width W1, the ratio of an area of the 45-degree magnet to a total magnet area on the surface of rotor 10 is 50[%]. Since the total magnet area is constant, the width W1 decreases as the width W2 increases. When the width W2=the width W1×4.0, the ratio of the area of the 45-degree magnets to the total magnet area is 80[%]. When the width W2=width W1×2.4, the ratio of the area of the 45-degree magnets to the total magnet area is 70[%]. When expressed in a percentage, the ratio of the area of the 45-degree magnets to the total magnet area in the surface area of the rotor 10 is preferably greater than 50[%] and less than 80[%].

While specific examples of the present disclosure have been described above in detail, these examples are merely illustrative and place no limitation on the scope of the patent claims. The technology described in the patent claims also encompasses various changes and modifications to the specific examples described above. The technical elements explained in the present description or drawings provide technical utility either independently or through various combinations. The present disclosure is not limited to the combinations described at the time the claims are filed. Further, the purpose of the examples illustrated by the present description or drawings is to satisfy multiple objectives simultaneously, and satisfying any one of those objectives gives technical utility to the present disclosure.

What is claimed is:

1. An electric motor having a rotor with a plurality of magnets arranged on a surface of the rotor, wherein:
when viewed along an axial direction of the rotor,
the plurality of magnets is arranged so that a direction of a magnetic pole of each of the plurality of magnets is rotated by 45 degrees sequentially from one to next along a circumferential direction of the rotor; and
a width of each of the magnets of which the magnet pole direction is inclined by 45 degrees relative to a radial direction of the rotor is wider than a width of each of the magnets of which the magnet pole direction coincides with the circumferential direction or the radial direction.

2. The electric motor of claim 1, wherein a ratio of the width of each of the magnets of which the magnet pole direction is inclined by 45 degrees relative to the radial direction to the width of each of the magnets of which the magnet pole direction coincides with the circumferential direction or the radial direction is greater than 1.0 and less than 4.0.

3. The electric motor of claim 1, wherein a boundary between the magnet of which the magnet pole direction is inclined by 45 degrees and the magnet of which the magnet pole direction coincides with the circumferential direction or the radial direction overlaps a straight line extending in the radial direction of the rotor.

4. The electric motor of claim 2, wherein a boundary between the magnet of which the magnet pole direction is inclined by 45 degrees and the magnet of which the magnet pole direction coincides with the circumferential direction or the radial direction overlaps a straight line extending in the radial direction of the rotor.
